(19) United States
(12) Patent Application Publication
(10) Pub. No.: US 2008/0144745 A1
(43) Pub. Date: Jun. 19, 2008

(54) CHANNEL ESTIMATION DEVICE, METHOD, AND COMPUTER READABLE MEDIUM FOR ESTIMATING CHANNEL BY A PREVIOUS CHANNEL SIGNAL

(75) Inventors: Kun-Chien Hung, Pingtung County (TW); David W. Lin, Hsinchu City (TW); Jian-Pei Liu, Keelung City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/683,523

(22) Filed: Mar. 8, 2007

(30) Foreign Application Priority Data
Dec. 13, 2006 (TW) 095146724

(51) Int. Cl. H04L 27/06

(52) U.S. Cl. 375/340

(57) ABSTRACT

A channel estimation device estimates channel by a previous signal, comprising an F evaluation module, a digitalization module, and a transferring module. The evaluation module processes a initial channel estimation according to at least one pilot signal of the previous signal. The digitalization module digitalizes a data carrier to a digital data signal according to the initial channel estimation. The transferring module transfers the digital data signal to at least one of specific references. The evaluation module receives a new data signal and modulates the new data signal according to the specific references.

This application claims priority to Taiwan Patent Application No. 095146724 filed on Dec. 13, 2006.

### CROSS-REFERENCES TO RELATED APPLICATIONS

Not applicable.

### BACKGROUND OF THE INVENTION

1. Field of the Invention

The present invention relates to an apparatus, a method, and a computer readable medium for channel estimation. More specifically, it relates to an apparatus, a method, and a computer readable medium for estimating a channel according to a previous signal.

2. Descriptions of the Related Art

In network structure, it needs to maintain transmission accuracy of data when different systems transmit data between each other. Conventional correction structure is built in media-access-control (MAC) or above layer. However, in wireless application, the industry develops standard of correction structure built in physical (PHY) layer to enhance transmission speed, such as HARQ standard.

Typically, HARD standard comprises three main categories. The first category requires a receiver to discard a received packet with irreparable error. And then the receiver asks the transmitter to resend a packet. The second category applies an incremental redundant method, which keeps the error packet in receiver and asks the transmitter to resend packets. After all packets are received in the receiver, the packets will be decoded collectively to enhance error correction performance. In second category, it allows decoding only when all packets are received. The third category improves the second category with individual-decoding character of a single packet.

However, in wireless communication standard, to ensure whether a received signal is the demanded signal in receiver, a transmitted signal from the transmitter has to carrier a specific pattern inserted in the demanded signal, such as pilot signal. Therefore the receiver can shape the received data to its original form according to the pilot signal, and then transform it into a digital packet for further process.

The pilot signal can only be used in PHY layer for channel estimation, but have no other function in data transmission in upper layers. Therefore the pilot signal occupies bandwidth of transmission but can only be used for channel estimation in PHY layer.

FIG. 1 shows a diagram of data transmission comprising interleaving pilot signals and data signals, the data is conforming to orthogonal frequency division multiple access, OFDMA. This is the worst case in OFDMA transmission, wherein each of the pilot signals 11 is denoted as a square in four corner of each transmission sequence, and each of the data signal 12 is denoted as a circle in the rest part of each transmission sequence. In the embodiment, each transmission sequence comprises four pilot signals 11 and eight data signals 12, and the pilot signal 11 can only be applied in channel estimation and thus reduces transmission efficiency.

Therefore, how to enhance transmission speed, efficiency, and quality are still objectives for the industry to endeavor.

### SUMMARY OF THE INVENTION

The primary objective of this invention is to provide a method for estimating a channel with a previous signal, comprising the steps of: processing an initial channel estimation according to at least one pilot signal of the previous signal; deriving at least one specific reference of a data carrier of the previous signal according to the initial channel estimation; receiving a renew data signal without carrying pilot signal; and modulating the renew data signal according to the specific references.

Another objective of this invention is to provide an apparatus for estimating a channel with a previous signal. The apparatus comprises an estimation module, a digitalization module, and a transformation module. The estimation module is configured for processing an initial channel estimation according to at least one pilot signal of the previous signal. The digitalization module is configured for transforming a data carrier of the previous signal to a digital data signal according to the initial channel estimation. The transformation module is configured for transforming the digital data signal to at least one specific reference. The estimation module receives a renew data signal, and the estimation module modulates the renew data signal according to the specific references.

Yet a further objective of this invention is to provide a computer readable medium storing a computer program to execute a channel estimation method of a channel estimation apparatus. The channel estimation method comprising steps of: processing an initial channel estimation according to at least one pilot signal of the previous signal; deriving at least one specific reference of a data carrier of the previous signal according to the initial channel estimation; receiving a renew data signal without carrying pilot signal; and modulating the renew data signal according to the specific references.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a diagram of conventional data transmission;

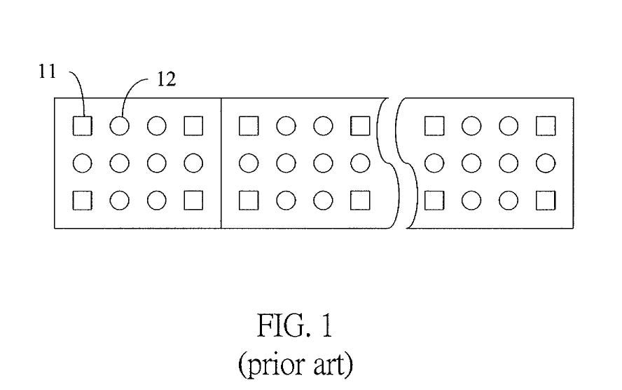

FIG. 2 is a first embodiment of the present invention;

FIG. 3 is a block diagram of the symbol generator of the first embodiment;

FIG. 4 is the second embodiment of the present invention;

FIG. 5A and FIG. 5B are waveforms of the previous signal before and after processing; and

FIG. 5C and FIG. 5D are waveforms of the renew data signal before and after processing.

### DESCRIPTION OF THE PREFERRED EMBODIMENT

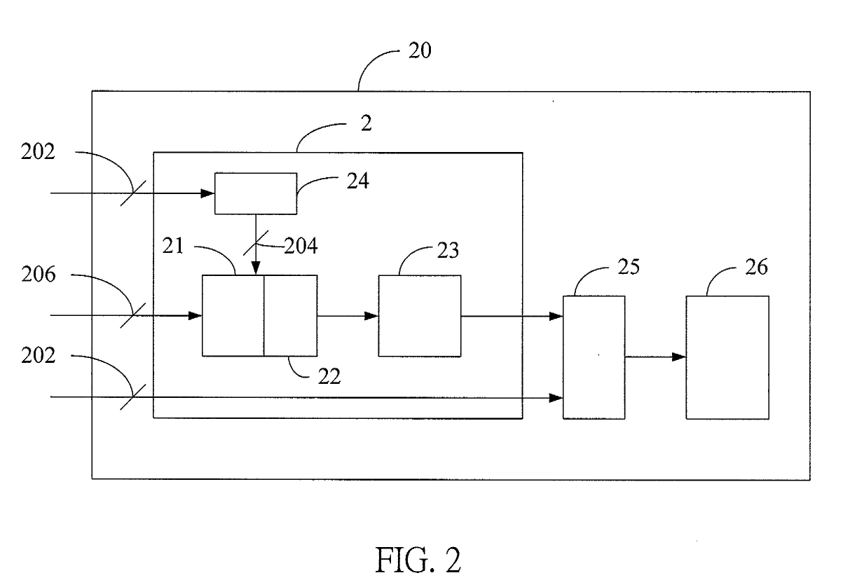

The first embodiment of the present invention is shown in FIG. 2, which is a channel estimation apparatus 2 comprised in a receiver 20 conforming to a HARQ transmission system. The channel estimation apparatus 2 comprises a front-end processing part, such as an estimation module comprising an equalization module respectively shown as a channel estimator 21 and a equalizer 22 in FIG. 2. The channel estimation apparatus 2 also comprises a digitalization module, such as a log likelihood ratio, LLR, processor 23, and a transformation module, such as a symbol generator 24. The receiver 20 further comprises a code combiner 25 and a forward error correction, FEC, decoder 26.

A previous signal 202 represents a previous signal which is initially processed. The previous signal comprises at least one pilot signal for the receiver 20 to shape received data to its original form, and then the receiver 20 processes the shaped data into a digital packet for further processing. The process of deriving the previous signal 202 is described as follows. At first, the front-end processing part of the receiver 20 receives a data signal. Then the channel evaluator 21 determines whether the data signal is needed to be processed according to the pilot signal carried in the data signal, and estimates the channel by various means such as least square channel estimation. Then the equalizer 22 equalizes the data signal after channel estimation. Then the LLR processor 23 transforms the equalized data signal into a digital data signal, i.e. the previous signal 202.

If the previous signal 202 is correctively transformed, the digital synthesizer 25 can directly process the previous signal 202, and outputs synthesized result to the FEC decoder 26 for decoding and deriving correct data to the HARQ transmission system.

If the previous signal 202 is not correctively transformed, the transmission system would ask the transmitter transmits a renew data signal. Meanwhile, the previous signal 202 is transmitted to the symbol generator 24. The symbol generator 24 then transforms the digital data contained in the previous signal 202 into a digital symbol signal 204 in wave formality as a characteristic reference.

Then the transmitter transmits a renew data signal 206, which does not contain pilot signal. After receiving the renew data signal 206, the channel estimator 21 compares it with the digital symbol signal 204, and processes channel estimation to the renew data signal 206 according to the digital symbol signal 204. Therefore the channel estimation of the renew data signal 206 can be done without referring to any pilot signal.

Then the digital synthesizer 25 jointly processes the renew data signal 206 processed by the LLR processor 206 and the previous signal 202, to correct the previous signal 202 and to transform it into correct data. If further correction is needed, the digital symbol signal 204 can by applied for further channel estimation until correct data is derived.

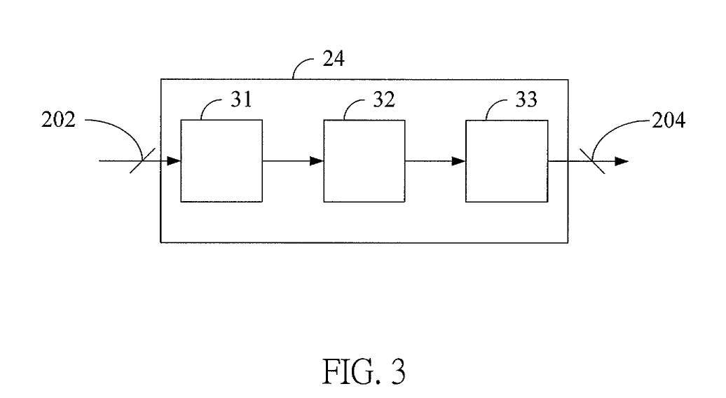

FIG. 3 shows a block diagram of the symbol generator 24 of the embodiment. It comprises a puncturing unit 31, an interleaver 32, and a data modulation unit 33. The data modulation unit 33 is configured to process soft-data modulation or hard-data modulation. After the previous signal 202 inputs to the symbol generator 24, the symbol generator 24 punctures and interleaves the previous signal 202, then modulates the previous signal 202 and outputs a digital symbol signal 204 in wave formality.

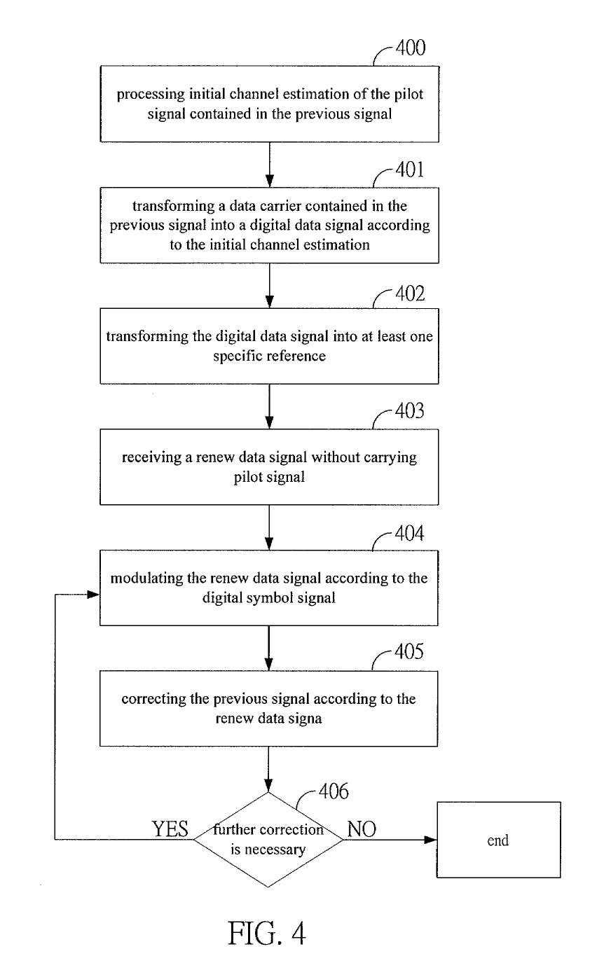

FIG. 4 is the second embodiment of the present invention. It is a channel estimation method applying in a channel estimation apparatus as described in the first embodiment. More specifically, the second embodiment is realized through operating modules of the channel estimation apparatus by an application program. The second embodiment estimates the channel according to a previous signal. If the previous signal cannot be transformed correctly, the transmitter is required to transmit a renew data signal for correction.

At first, step 400 is executed to enable an estimation module for processing initial channel estimation of the pilot signal contained in the previous signal by least square channel estimation. Then step 401 is executed to enable a digitalization module for transforming a data carrier contained in the previous signal into a digital data signal according to the initial channel estimation. More specifically, the step 401 comprises two steps. First, it is executed to enable an equalization module for equalizing the data carrier contained in the previous signal according to the initial channel estimation, for preparing for the following digitalization process. Second, it is executed to enable the digitalization module transform the data carrier into a digital data signal for later processing according to the equalized data carrier.

Then step 402 is executed to enable a transformation module for transforming the digital data signal into at least one specific reference. In the second embodiment, the transformation module transforms the digital data signal into the specific reference with a digital symbol signal in wave formality. Since the digital symbol signal is derived from the digital data signal, and the digital data signal is derived from the initial channel estimation, the digital symbol signal contains channel characters, and is applied for modulating later receiving signals.

Then step 403 is executed to enable the estimation module for receiving a renew data signal without carrying pilot signal. Thus the renew data signal can carry more useful data. Taking OFDMA transmission as an example, the renew data signal can carry extra fifty percentage data more than the previous signal does.

Then step 404 is executed to enable the estimation module for modulating the renew data signal according to the digital symbol signal. Since the digital symbol signal contains channel characters, it can be applied in modulating all data signals carried in the renew data signal.

Then step 405 is executed to enable a code combiner for correcting the previous signal according to the renew data signal. Then step 406 is executed to determine whether further correction is necessary. If it is necessary, then step 404 is executed again to repeat modulation. If it is not necessary, the correction is ended.

The aforementioned methods can use a computer readable medium for storing a computer program to execute the aforementioned steps. The computer readable medium can be a floppy disk, a hard disk, an optical disk, a flash disk, a tape, a database accessible from a network or a storage medium with the same functionality that can be easily thought by people skilled in the art.

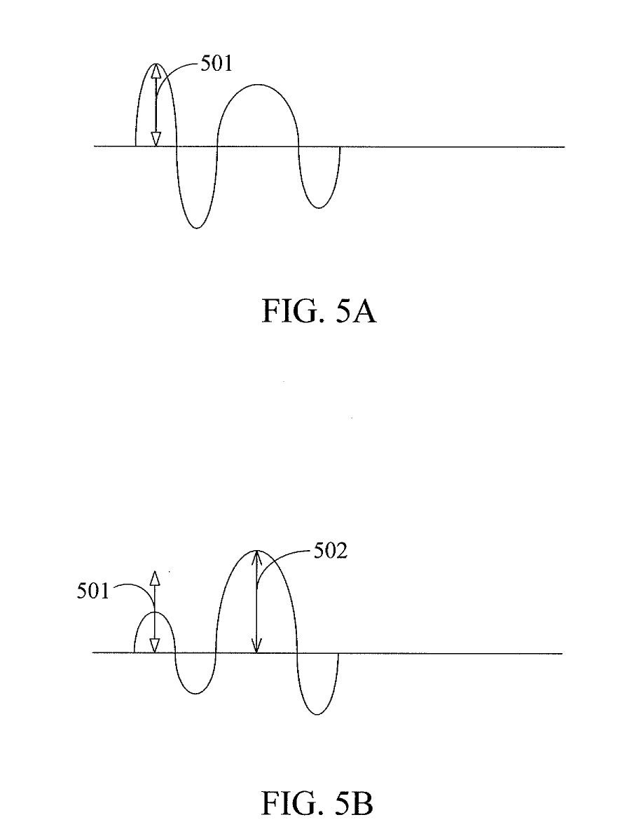

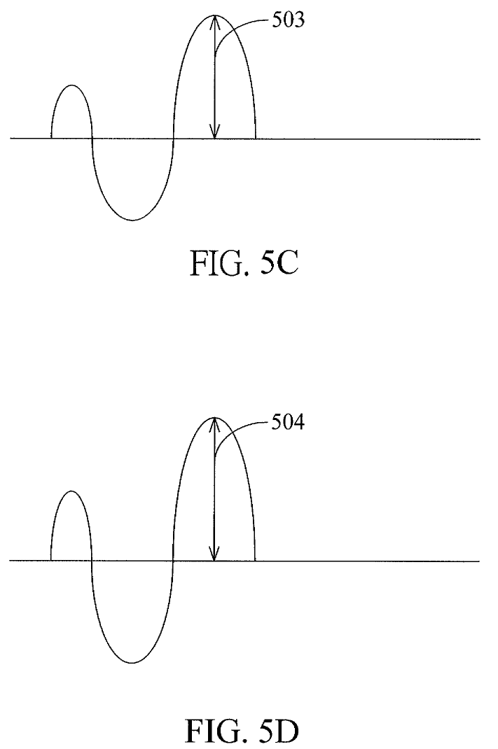

FIG. 5A to FIG. 5D show waveforms of the previous signal before and after processing, and waveforms of the renew data signal before and after processing.

FIG. 5A shows waveform of the previous signal before processing, it comprises a pilot signal 501. FIG. 5B shows waveform of the previous signal after processing, it comprises a specific reference 502. The channel estimation apparatus processes the initial channel estimation according to the pilot signal 501.

FIG. 5C shows waveform of the renew data signal before processing, it comprises a data signal 503. FIG. 5D shows waveform of the renew data signal after processing, it comprises a modulated data signal 504 of data signal 503. The data signal 503 and other data signals are modulated according to the specific reference 502.

According to the aforementioned description, the present invention can process a renew data signal without carrying pilot signal, thus it allows more data signal being transmitted when transmitting the renew data signal. Meanwhile, the renew data signal is correctly modulated according to specific reference of the channel. Then present invention can thus improve the conventional channel estimation apparatus by transmitting the renew data signal without carrying pilot signal, and enhance transmission efficiency.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not filly disclosed in the above descriptions, they have substantially been covered in the following claims as appended.

What is claimed is:

1. A method for estimating a channel with a previous signal, comprising the steps of:
processing an initial channel estimation according to at least one pilot signal of the previous signal;
deriving at least one specific reference of a data carrier of the previous signal according to the initial channel estimation;
receiving a renew data signal without carrying pilot signal; and
modulating the renew data signal according to the specific references.

2. The method as claimed in claim 1, wherein the step of deriving at least one specific reference of a data carrier of the previous signal according to the initial channel estimation comprises steps of:
transforming the data carrier to a digital data signal according to the initial channel estimation; and
deriving the specific references according to the digital data signal.

3. The method as claimed in claim 2, wherein the step of transforming the data carrier to a digital data signal comprises steps of:
equalizing the data carrier according to the initial channel estimation; and
transforming the data carrier to the digital data signal according to the equalized data carrier.

4. The method as claimed in claim 1, wherein the step of modulating the renew data signal according to the specific references comprises steps of:
transforming the specific references to a digital symbol signal in wave formality; and
modulating the renew data signal according to the digital symbol signal.

5. The method as claimed in claim 1, wherein the method is adapted to a transmission system conforming to HARQ standard.

6. An apparatus for estimating a channel with a previous signal, comprising:
an estimation module for processing an initial channel estimation according to at least one pilot signal of the previous signal;
a digitalization module for transforming a data carrier of the previous signal to a digital data signal according to the initial channel estimation; and
a transformation module for transforming the digital data signal to at least one specific reference;
wherein the estimation module receives a renew data signal, and the estimation modulates the renew data signal according to the specific references.

7. The apparatus as claimed in claim 6, further comprising an equalizing module for equalizing the data carrier according to the initial channel estimation;
wherein the digital module transforms the data carrier to the digital data signal according to the equalized data carrier.

8. The apparatus as claimed in claim 6, wherein the transformation module transforms the digital data signal to the specific references with a digital symbol signal in wave formality.

9. The apparatus as claimed in claim 6, wherein the apparatus is adapted to a transmission system conforming to HARQ standard.

10. A computer readable medium storing a computer program to execute a channel estimation method of a channel estimation apparatus, the channel estimation method comprising steps of:
processing an initial channel estimation according to at least one pilot signal of the previous signal;
deriving at least one specific reference of a data carrier of the previous signal according to the initial channel estimation;
receiving a renew data signal without carrying pilot signal; and
modulating the renew data signal according to the specific references.

11. The computer readable medium as claimed in claim 10, wherein the step of deriving at least one specific reference of a data carrier of the previous signal according to the initial channel estimation comprises steps of:
transforming the data carrier to a digital data signal according to the initial channel estimation; and
deriving the specific references according to the digital data signal.

12. The computer readable medium as claimed in claim 11, wherein the step of transforming the data carrier to a digital data signal comprises steps of:
equalizing the data carrier according to the initial channel estimation; and
transforming the data carrier to the digital data signal according to the equalized data carrier.

13. The computer readable medium as claimed in claim 10, wherein the step of modulating the renew data signal according to the specific references comprises steps of:
transforming the specific references to a digital symbol signal in wave formality; and
modulating the renew data signal according to the digital symbol signal.

14. The computer readable medium as claimed in claim 10, wherein the method is adapted to a transmission system conforming to HARQ standard.
